(19) United States
(12) Patent Application Publication
(10) Pub. No.: US 2023/0013023 A1
(43) Pub. Date: Jan. 19, 2023

(54) ARCHITECTURAL INTERFACES FOR GUEST SOFTWARE TO SUBMIT COMMANDS TO AN ADDRESS TRANSLATION CACHE IN XPUs

(71) Applicant: Intel Corporation, Santa Clara, CA (US)

(72) Inventors: Rupin H. Vakharwala, Hillsboro, OR (US); Philip R. Lantz, Cornelius, OR (US)

(73) Assignee: Intel Corporation, Santa Clara, CA (US)

(21) Appl. No.: 17/951,024

(22) Filed: Sep. 22, 2022

(51) Int. Cl. G06F 12/1081; G06F 12/0891

(52) U.S. Cl. CPC G06F 12/1081; G06F 12/0891

(57) ABSTRACT

In one embodiment, an apparatus includes a processor comprising an address translation cache (ATC); a shared work queue (SWQ) associated with the ATC, and a port to couple to a host processor over a Peripheral Component Interconnect Express (PCIe)-based link. The apparatus also includes circuitry to receive address translation information from a memory management unit of the host processor that includes virtual memory address to physical memory address translations, store the address translation information in the ATC, receive an invalidation command from the host processor indicating an invalidation of address translation information stored in the ATC, modify the address translation information in the ATC based on the invalidation command, and store completion data in a memory location indicated by the invalidation command.

### FIELD

This disclosure pertains to computing systems, and in particular (but not exclusively) to architectural interfaces by which guest software running on host software can submit commands to an address translation cache of a processor (XPU).

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc. As the processing power grows along with the number of devices in a computing system, the communication between sockets and other devices becomes more critical. Accordingly, interconnects, have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures. Interconnect architectures may be based on a variety of technologies, including Peripheral Component Interconnect Express (PCIe), Compute Express Link (CXL), Universal Serial Bus, and others.

### BRIEF DESCRIPTION OF THE DRAWINGS

FIG. 1 illustrates an embodiment of a computing system including an interconnect architecture.

FIG. 2 illustrates an embodiment of a interconnect architecture including a layered stack.

FIGS. 3A-3D illustrate example transaction layer packet (TLP) formats for use within an interconnect architecture.

FIG. 4 illustrates an embodiment of a transmitter and receiver pair for an interconnect architecture.

FIG. 5 illustrates an example implementation of a computing system including a host processor and an accelerator coupled by a link.

FIG. 6 illustrates an example implementation of a computing system including two or more interconnected processor devices.

FIG. 7 illustrates a representation of an example port of a device including a layered stack.

FIG. 8 illustrates an example system implementing shared virtual memory (SVM).

FIG. 9 illustrates an example of PCIe-based ATS in current implementations.

FIG. 10 illustrates an example implementation of PCIe-based ATS in embodiments of the present disclosure.

FIG. 11 illustrates an example implementation of multiple SWQs per ATC in accordance with embodiments of the present disclosure.

FIG. 12 illustrates a flow diagram of an example process of processing an address translation invalidation command in accordance with embodiments of the present disclosure.

FIG. 13 illustrates an embodiment of a block diagram for a computing system including a multicore processor.

FIG. 14 illustrates an embodiment of a block for a computing system including multiple processors.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice embodiments of the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring embodiments of the present disclosure.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the present disclosure.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard, Rack Scale, Cloud, Fog, Enterprise, etc.), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

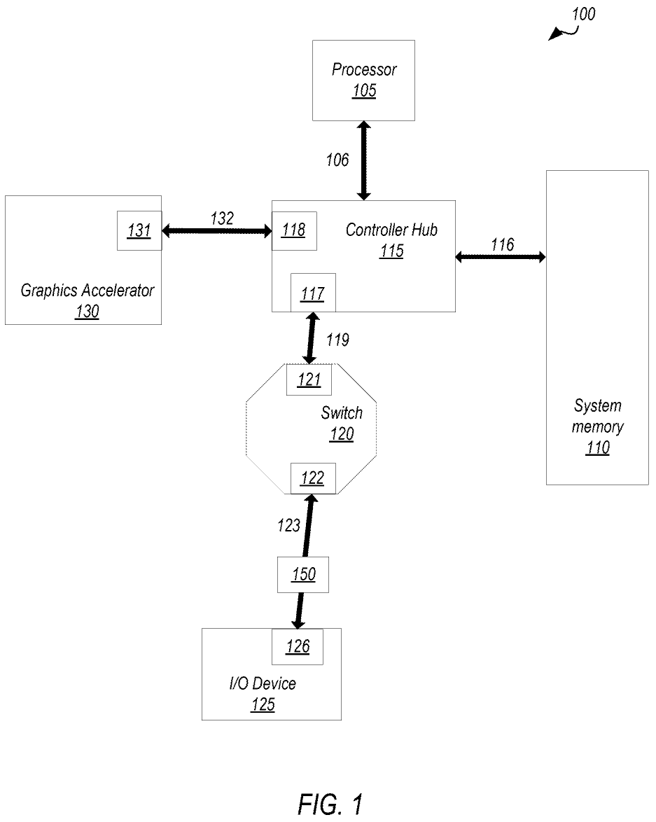

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard. In some implementations, the system may include logic to implement multiple protocol stacks and further logic to negotiation alternate protocols to be run on top of a common physical layer, among other example features.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105. Further, one or more links (e.g., 123) of the system can include one or more extension devices (e.g., 150), such as retimers, repeaters, etc.

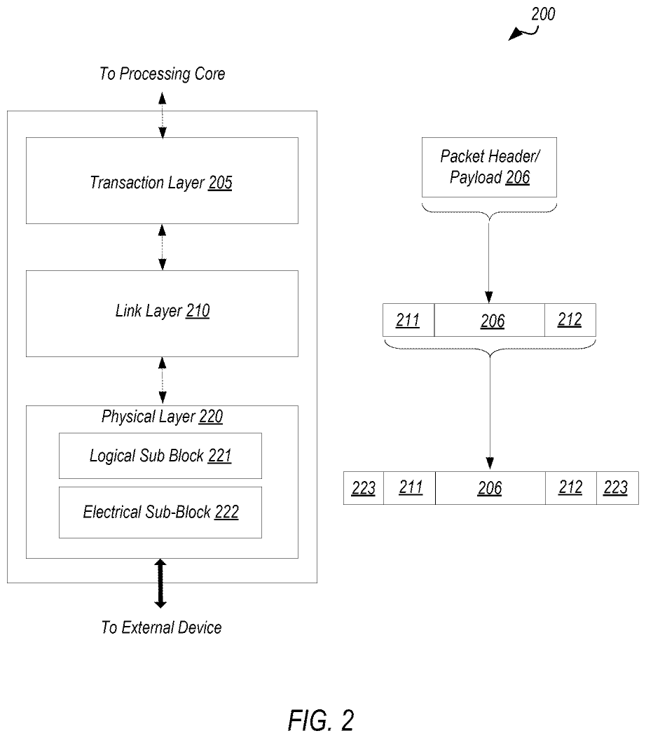

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 205 assembles packet header/payload 206. Format for current packet headers/payloads may be found in the PCIe specification at the PCIe specification website.

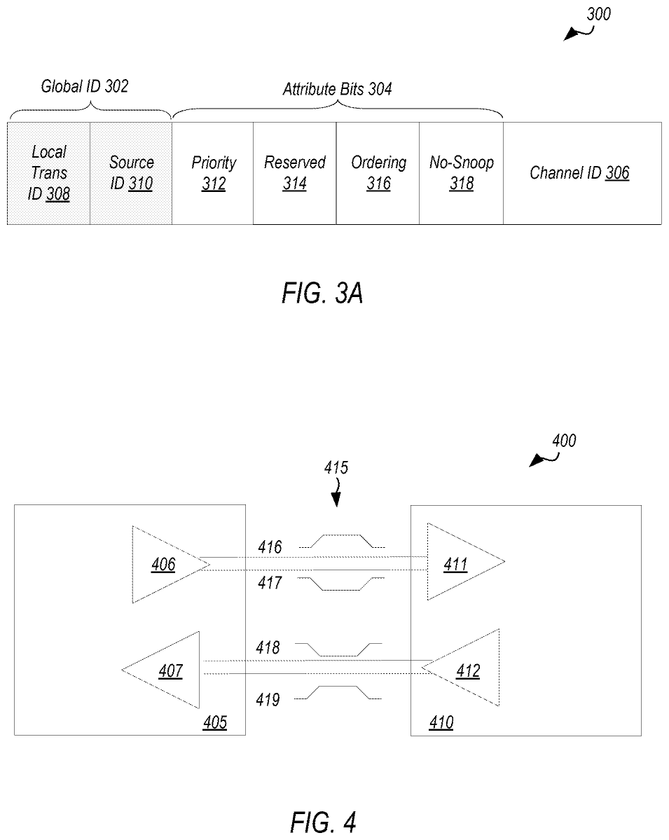

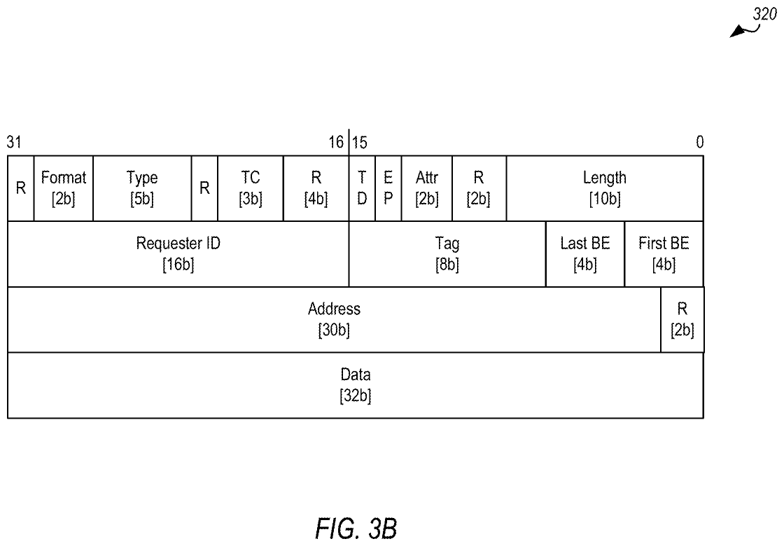

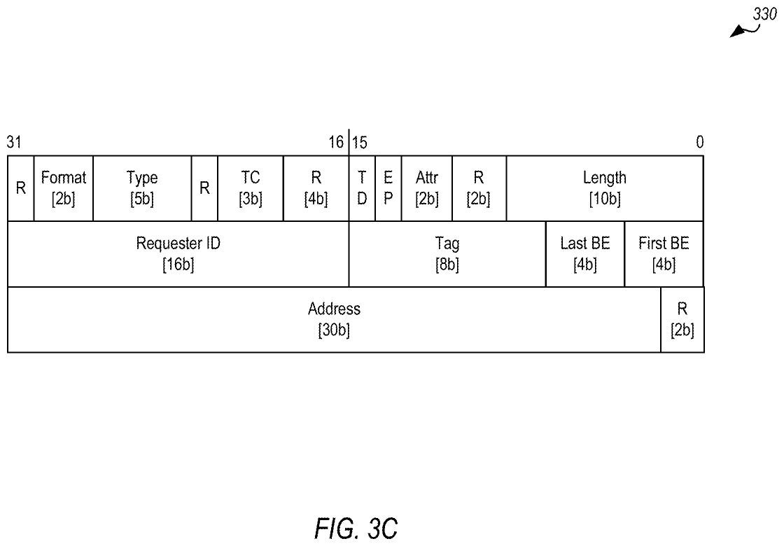

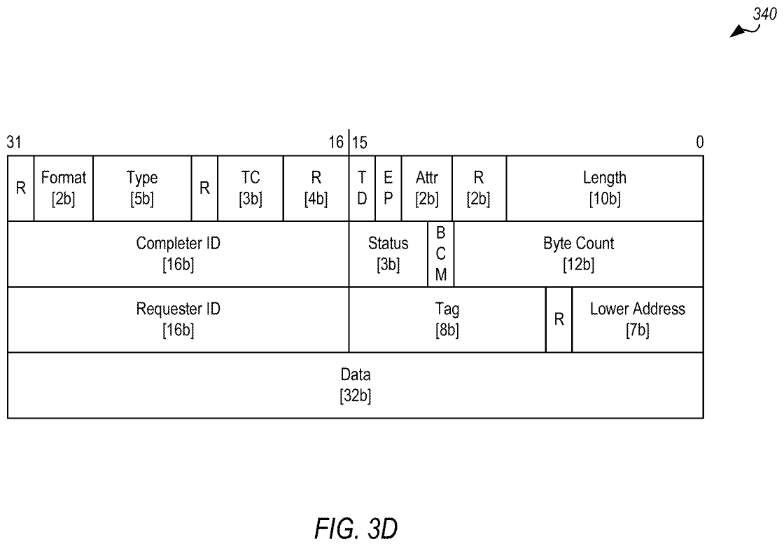

FIGS. 3A-3D illustrate example transaction layer packet (TLP) formats for use within an interconnect architecture, such as a PCIe-based interconnect architecture. Referring to FIG. 3A, an example of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

Referring to FIG. 3B, an example memory write request TLP format 320 is shown. The example memory write request TLP format 320 includes a number of Reserved (R) bits throughout. In addition, a Format (Fmt) field and Type field are included, and together, these fields may indicate that the TLP is a Memory Write Request. A Traffic Class (TC) field is included to indicate a certain traffic class or virtual channel (VC) for the request. A TLP Digest (TD) bit is included, which may indicate whether there extra CRC on the TLP data. A Length field indicates how much data the TLP includes (in this example, there is one doubleword (i.e., 32 bits) of data). A Requester ID field is included to indicate the sender of the TLP. A Tag field is also included for the sender to indicate certain data of the sender's choosing. A First Byte Enable (BE) field is included, and may allow for choosing which of the four bytes in the first data DW are valid, and should be written. In addition, a Last BE field is included, and may allow for choosing which of the four bytes in the last data DW are valid (in this example, there is only one DW of data, and this would be zero). An Address field is included to indicate the address to which the data is to be written, and finally, a Data field includes the data to be written in response to the memory write request. In some cases, a memory write request TLP may be a “posted” transaction that does not require a corresponding completion indication (e.g., a completion TLP).

Referring to FIG. 3C, an example memory read request TLP format 330 is shown. The example format 330 is the same as the format 320 of FIG. 3B, but with the Data field removed. However, in the example format 330, the Format and Type fields now indicate that the packet is a memory read request, and the Length field indicates how many DWs of data are to be read in response to the TLP. Further, The two BE fields indicate the same as in format 320, except that they pick which bytes to read rather than which bytes to write. In some cases, a memory read request TLP may be a “non-posted” transaction that does require a corresponding completion indication (e.g., a completion TLP).

Referring to FIG. 3D, an example completion TLP format 340 is shown. A completion TLP may be sent by a completer in response to a non-posted type of transaction (e.g., a memory read request). In the example format 340, the Format and Type fields indicate that the TLP is completion type. The Length field indicates a number of DW of data in the TLP. The Completer ID field indicates the device completing the request (e.g., doing a read in response to a read request, e.g., a read request TLP formatted similar to 330), and the Requester ID indicates the device that initiated the request (e.g., the device that sent a read request TLP formatted similar to 330). The Byte Count field may indicate a number of valid payload bytes in the TLP. The Tag may indicate any value. The Lower Address field indicates the 7 least significant bits of the address in the associated request packet (e.g., the Address field in the memory read request TLP). The Status field may indicate a status of the completion, e.g., successful/unsuccessful. The BCM field may be used with PCI-X implementations, and otherwise may be zero.

Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/412 and a receive pair 411/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., PCIe), while others (e.g., Displayport) may not and may even including only transmit or only receive pairs, among other examples.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

A variety of interconnect architectures and protocols may utilize the concepts discussed herein. With advancements in computing systems and performance requirements, improvements to interconnect fabric and link implementations continue to be developed, including interconnects based on or utilizing elements of PCIe or other legacy interconnect platforms. In one example, Compute Express Link (CXL) has been developed, providing an improved, high-speed CPU-to-device and CPU-to-memory interconnect designed to accelerate next-generation data center performance, among other application. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0), leveraging the PCIe physical and electrical interface to provide advanced protocol in areas include I/O, memory protocol (e.g., allowing a host processor to share memory with an accelerator device), and coherency interface.

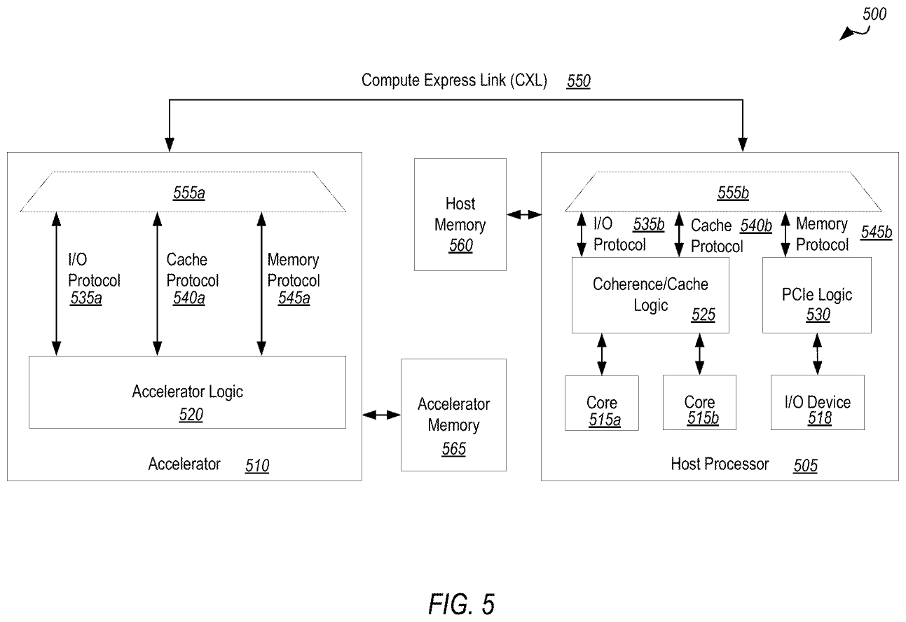

Turning to FIG. 5, a simplified block diagram 500 is shown illustrating an example system utilizing a CXL link 550. For instance, the link 550 may interconnect a host processor 505 (e.g., CPU) to an accelerator device 510. In this example, the host processor 505 includes one or more processor cores (e.g., 515a-b) and one or more I/O devices (e.g., 518). Host memory (e.g., 560) may be provided with the host processor (e.g., on the same package or die). The accelerator device 510 may include accelerator logic 520 and, in some implementations, may include its own memory (e.g., accelerator memory 565). In this example, the host processor 505 may include circuitry to implement coherence/cache logic 525 and interconnect logic (e.g., PCIe logic 530). CXL multiplexing logic (e.g., 555a-b) may also be provided to enable multiplexing of CXL protocols (e.g., I/O protocol 535a-b (e.g., CXL.io), caching protocol 540a-b (e.g., CXL.cache), and memory access protocol 545a-b (CXL.mem)), thereby enabling data of any one of the supported protocols (e.g., 535a-b, 540a-b, 545a-b) to be sent, in a multiplexed manner, over the link 550 between host processor 505 and accelerator device 510.

In some implementations, a Flex Bus™ port may be utilized in concert with CXL-compliant links to flexibly adapt a device to interconnect with a wide variety of other devices (e.g., other processor devices, accelerators, switches, memory devices, etc.). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

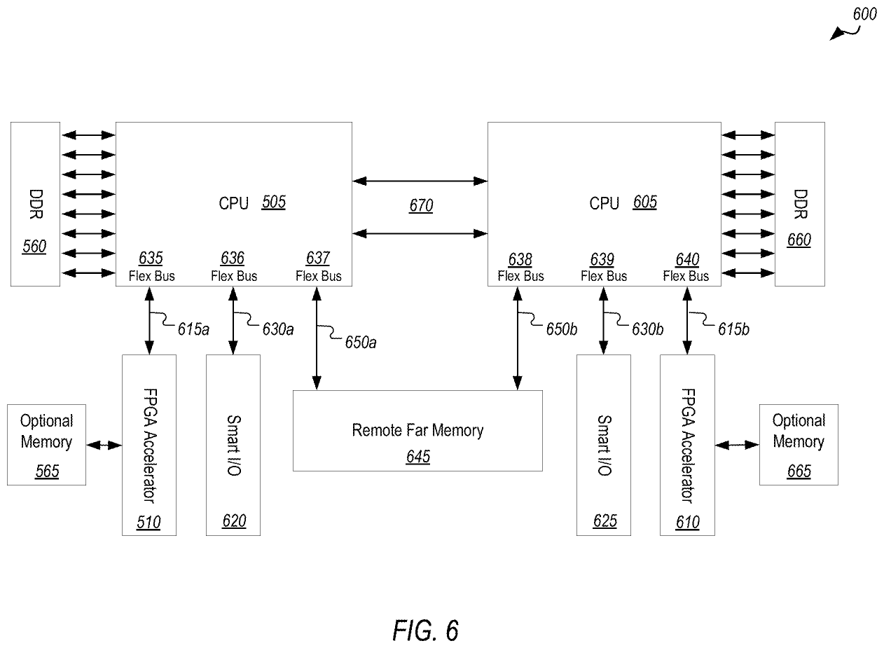

Turning to FIG. 6, an example is shown (in simplified block diagram 600) of a system utilizing Flex Bus ports (e.g., 635-640) to implement CXL (e.g., 615a-b, 650a-b) and PCIe links (e.g., 630a-b) to couple a variety of devices (e.g., 510, 610, 620, 625, 645, etc.) to a host processor (e.g., CPU 505, 605). In this example, a system may include two CPU host processor devices (e.g., 505, 605) interconnected by an inter-processor link 670 (e.g., utilizing a UltraPath Interconnect (UPI), Infinity Fabric™, or other interconnect protocol). Each host processor device 505, 605 may be coupled to local system memory blocks 560, 660 (e.g., double data rate (DDR) memory devices), coupled to the respective host processor 505, 605 via a memory interface (e.g., memory bus or other interconnect).

As discussed above, CXL links (e.g., 615a, 650b) may be utilized to interconnect a variety of accelerator devices (e.g., 510, 610). Accordingly, corresponding ports (e.g., Flex Bus ports 635, 640) may be configured (e.g., CXL mode selected) to enable CXL links to be established and interconnect corresponding host processor devices (e.g., 505, 605) to accelerator devices (e.g., 510, 610). As shown in this example, Flex Bus ports (e.g., 636, 639), or other similarly configurable ports, may be configured to implement general purpose I/O links (e.g., PCIe links) 630a-b instead of CXL links, to interconnect the host processor (e.g., 505, 605) to I/O devices (e.g., smart I/O devices 620, 625, etc.). In some implementations, memory of the host processor 505 may be expanded, for instance, through the memory (e.g., 565, 665) of connected accelerator devices (e.g., 510, 610), or memory extender devices (e.g., 645, connected to the host processor(s) 505, 605 via corresponding CXL links (e.g., 650a-b) implemented on Flex Bus ports (637, 638), among other example implementations and architectures.

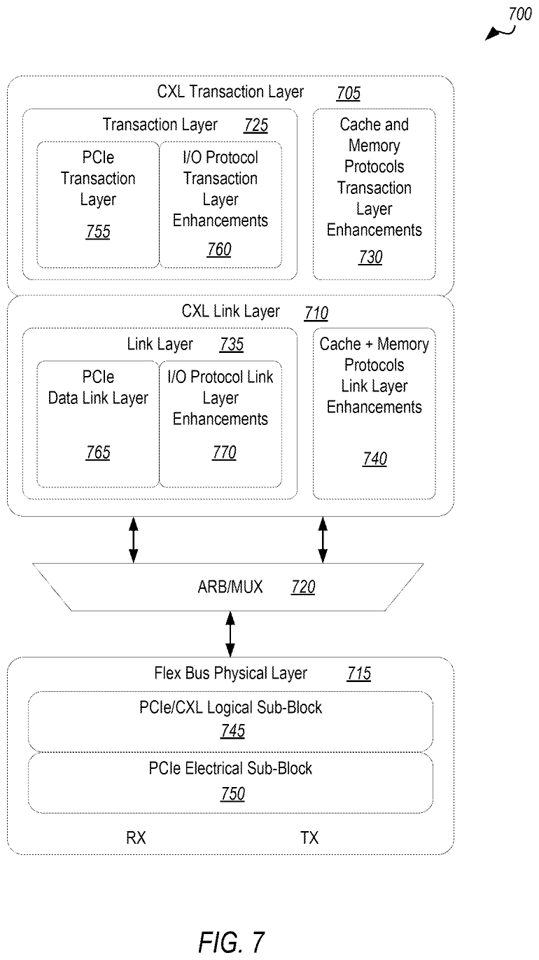

FIG. 7 is a simplified block diagram illustrating an example port architecture 700 (e.g., Flex Bus) utilized to implement CXL links. For instance, Flex Bus architecture may be organized as multiple layers to implement the multiple protocols supported by the port. For instance, the port may include transaction layer logic (e.g., 705), link layer logic (e.g., 710), and physical layer logic (e.g., 715) (e.g., implemented all or in-part in circuitry). For instance, a transaction (or protocol) layer (e.g., 705) may be subdivided into transaction layer logic 725 that implements a PCIe transaction layer 755 and CXL transaction layer enhancements 760 (for CXL.io) of a base PCIe transaction layer 755, and logic 730 to implement cache (e.g., CXL.cache) and memory (e.g., CXL.mem) protocols for a CXL link. Similarly, link layer logic 735 may be provided to implement a base PCIe data link layer 765 and a CXL link layer (for CXl.io) representing an enhanced version of the PCIe data link layer 765. A CXL link layer 710 may also include cache and memory link layer enhancement logic 740 (e.g., for CXL.cache and CXL.mem).

Continuing with the example of FIG. 7, a CXL link layer logic 710 may interface with CXL arbitration/multiplexing (ARB/MUX) logic 720, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 715 based on a PCIe physical layer (e.g., PCIe electrical PHY 750). For instance, a Flex Bus physical layer may be implemented as a converged logical physical layer 745 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., ×16, ×8, ×4, ×2, ×1, etc.). In PCIe mode, links implemented by the port 700 may be fully compliant with native PCIe features (e.g., as defined in the PCIe specification), while in CXL mode, the link supports all features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that each have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transaction involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Master and the Mem device is regarded as the CXL.mem Subordinate. The CXL.mem Master is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

PCIe-based environments, such as those described above, may implement an Address Translation Service (ATS) that allows XPUs on peripheral I/O devices (e.g., 125) to build an Address Translation Cache (ATC) to improve performance. As used herein, an XPU may refer to a processor or accelerator that connects to another processor (e.g., a central processor unit (CPU) of a system-on-chip (SoC)) over an JO fabric (e.g., PCIe or CXL as described above). With current PCIe standards and techniques, guest software running on host software (e.g., a virtual machine or other type of guest software running on an operating system) cannot communicate with an ATC directly and must always request the host software to perform the communication with the ATC on the guest software's behalf. Thus, the host software serves as a “middle-man” and there is latency overhead for going through the host software, resulting in lower performance.

Some proposals for addressing this issue have included allowing guest software to submit commands directly to an IOMMU, which may then route some of the commands to the ATC. However, this still does not allow the guest software to directly send the commands to the ATC. Some other proposals have utilized EnqCmdS and SharedWorkQueue concepts, whereby guest software sends commands to the XPU, but this approach still utilizes multiple agents in the middle, resulting in lower performance and additional security exposures.

Embodiments herein propose a new architectural interface for ATCs that would allow guest software to send commands to ATCs directly without host software involvement. In particular embodiments, for example, commands may be sent by guest software to an ATC to using existing capabilities, with an interface that is generic enough that it can easily be extended to provide additional commands, e.g., for new capabilities in ATS 2.0 and beyond. The guest software can send commands directly to the ATC, bypassing the IOMMU and host software. The ATC may implement two copies of the interface proposed herein to receive commands from software: one instance of the interface can be used exclusively by host software and the other instance can be shared across many guest software instances. By allowing guest software to send commands to the ATC directly, both performance reducing components described above may be reduced or eliminated, and higher performance for virtualized systems may be achieved accordingly.

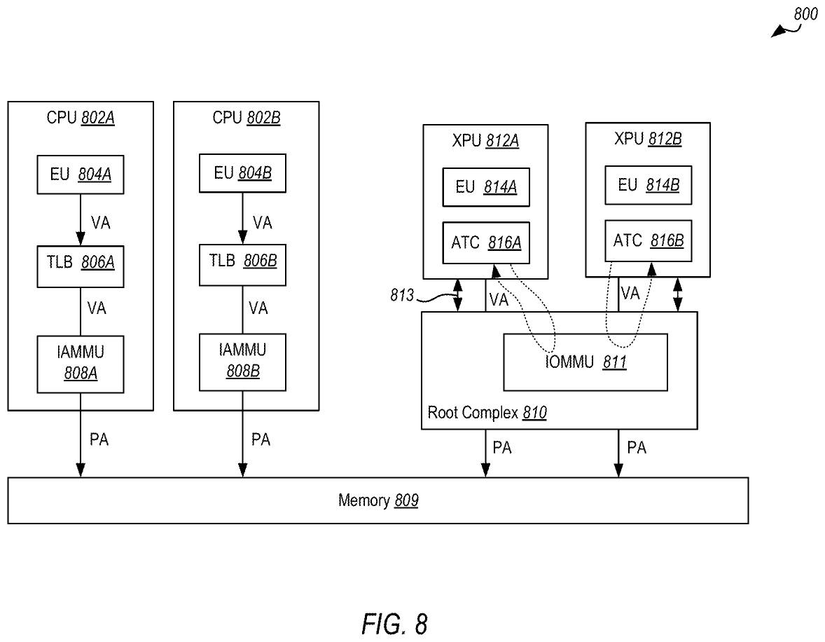

FIG. 8 illustrates an example system 800 implementing shared virtual memory (SVM). The system 800 includes central processing units (CPU)) 802 that each include an execution unit 804, translation lookaside buffer (TLB) 806, and a memory management unit (IAMMU) 808. In some instances, the IAMMU may be a page miss handler. The system 800 also includes a root complex 810 that includes an IOMMU 811. The CPUs 802 and the root complex 810 are coupled to a memory 809. In some embodiments, the CPUs, memory 809, and root complex 810 may be embodied in a system-on-chip (SoC). The system also includes multiple XPUs 812 that each include an execution unit 814 and an address translation cache (816). In certain embodiments, the XPUs 812 may be accelerators. The XPUs 812 are coupled to the root complex 810 through IO links (e.g., 813), which may be implemented as a PCIe-based link, a CXL-based link, or a link based on another type of interconnect protocol.

The system 800 may support SVM, which can involve applications running on the execution units 804 submitting work to the XPUs 812 using virtual addresses (VAs), with the expectation that the XPUs 812 will be able to manipulate portions of the memory 809, which are accessed by physical addresses (PAs), using the VAs in the same manner as the CPUs 802 that submitted the work to the XPUs 812. VA to PA translations (page tables) may be stored in the TLBs 806 (and may be setup by Virtual Machines (VMs) or Virtual Machine Monitors (VMMs) executing on the CPUs 802), and the IAMMUs 808 may utilize the stored translations to generate a PA based on a VA provided by the execution unit 804. For the XPUs 812 to implement SVM, the IOMMU 811 of the root complex 810 may store the VA to PA translations, allowing the XPUs 812 to manipulate the data structures in the memory 809 in the same manner as the CPUs 802. The IOMMU 811 also enables the XPUs 812 to handle page-faults, removing the requirement for the XPUs 812 to pin their memory, and thereby allow a much larger working set size.

One challenge that XPUs face when trying to take advantage of SVM is to build/implement PCIe-based Address Translation Service (ATS). Currently, ATS supports the following functionalities. First, ATS may support an ATC to IOMMU interface, which allows an XPU 812 to request address translations from the IOMMU (this may also be referred to as a “Translation Agent (TA)”) and cache the results in the ATC 816. Translation results from the ATC are then used in a translated request to access memory. Second, ATS may support a system software to ATC interface, which allows the system software to issue invalidations to an ATC to remove stale translations (e.g., translations that are no longer valid/in use) from the ATC. Third, ATS may support an ATC to system software interface that allows an XPU to report page-faults to the system software.

In current implementations, as will be described further below, guest software (e.g., a VM) executing on the CPUs 802 may not directly communicate invalidations according to the second interface described above to ATCs 816 without going through host software (e.g., VMM or OS) or the IOMMU 811. However, embodiments herein propose a new, high-performance interface that can allow for such direct communications. In particular, an interface as described herein may allow guest software executing on the CPUs 802 to send commands directly to an ATC 816 associated with an XPU 812 without utilizing the IOMMU 811 or host software executing on the CPU 802 as a “middle agent”.

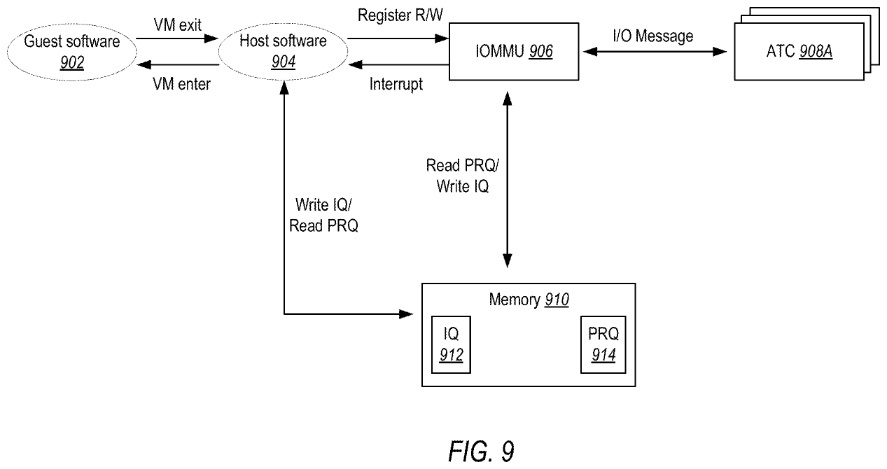

FIG. 9 illustrates an example of PCIe-based ATS in current implementations. In the example shown, guest software 902 is executing via host software 904 on a host processor (e.g., CPUs 802 of the system 800). To send an invalidation for an address translation to an ATC 908 (e.g., ATCs 816 of the system 800), the guest software 902 must perform a VMexit and then request host software 904 to send commands to an ATC 908 on its behalf. After servicing the request from the guest software 902, the host software 904 performs a VMenter to hand control back to the guest software 902. The VMexit operation adds latency to the command sent to the ATC 908 and directly impacts latency to complete the command. For systems utilized SVM, the ATC invalidation latency increase can directly impact TLB-shoot-down latencies for CPUs and adversely impact system performance. In addition, running the host software (even for a small fraction of time) between the VMexit and VMenter as described above, can cause the code/data from the host to pollute CPU caches and kick out code/data for the guest software, incurring additional performance overhead.

To service the command on behalf of the guest software 902, the host software 904 must also use the IOMMU 906 (e.g., IOMMU 811 of the root complex 810 of the system 800) as the “middle-man”. For instance, the host software 904 writes, via an invalidation command, to an invalidation queue (IQ) 912 in the memory 910. The host software 904 then writes to a register in the IOMMU 906 to notify the IOMMU of the IQ write. Thereafter, IOMMU 906 reads from the IQ 912 and formats an invalidation message in the PCIe-based protocol to communicate the invalidation to the ATCs 908.

For page faults, the ATC 908 sends a message to the IOMMU 906 via a PCIe-based message, and the IOMMU 906 then writes to a page request queue (PRQ) 914 in the memory 910 to indicate the page fault. The IOMMU 906 then issues an interrupt to the host software 904, which reads the PRQ 914 and handles the page fault accordingly (e.g., for or on behalf of the guest software 902).

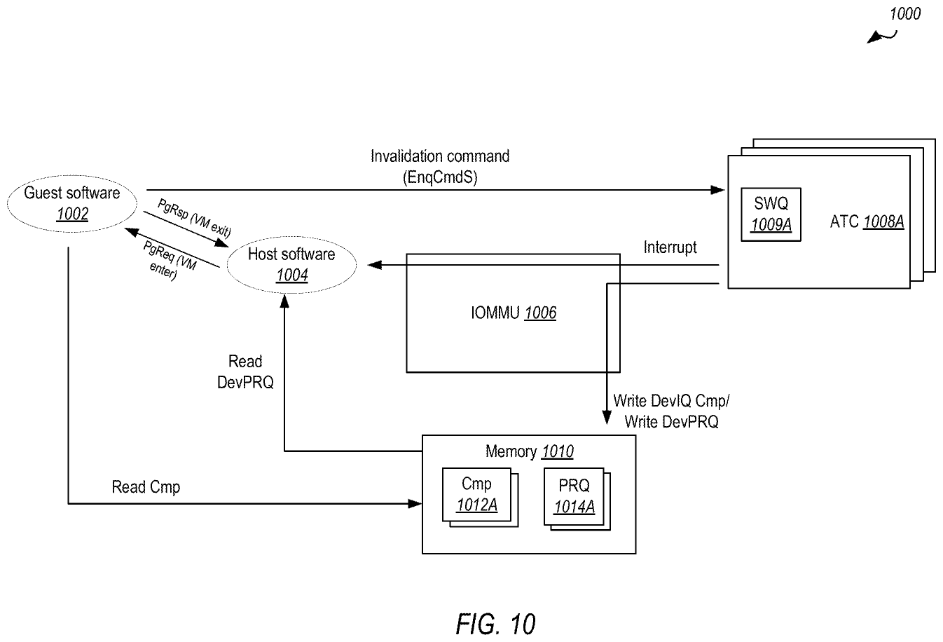

FIG. 10 illustrates an example implementation of PCIe-based ATS in accordance with embodiments of the present disclosure. In the example shown, guest software 1002 is executing via host software 1004 on a host processor (e.g., CPUs 8042 of the system 800) as in the example shown in FIG. 9. However, in the example shown, the IQs are no longer implemented in the memory to indicate invalidations to the ATCs 1008, and accordingly the IOMMU 1006 is not needed as a middle agent). Instead, in embodiments herein, guest software 1002 sends a command directly to the ATCs 1008 to indicate an invalidation of certain translations stored in the ATC(s), without the need for host software or the IOMMU as an intermediary. For example, in some embodiments, the guest software 1002 can issue an EnqCmdS command to a shared work queue (SWQ) 1009 in or associated with the ATC 1008. The SWQ 1009 may be separate from a SWQ that is implemented by the XPU associated with the 1008 (e.g., a SWQ that is used to queue work from CPUs).

The command from the guest software 1002 can include, among other things (e.g., see below) an indication of which address translation information to invalidate and an address in the memory 1010 to which the ATC 1008 is to write a completion after the invalidation is complete (which may be referred to as a completion address 1012). Thus, after the ATC 1008 invalidates stored translation(s) as indicated in the invalidation command from the guest software 1002, it writes to the completion address 1012 in the memory 1010, and the guest software 1002 can read the completion 1012 from the memory 1010 to ensure that the invalidation has been processed by the ATC 1008. The ATC 1008 can write a particular value to the completion address 1012 based on the outcome of the invalidation. For instance, the ATC 1008 can write a first value (e.g., a value of 1, or all 1s) to the completion address 1012 upon a successful invalidation, and where an error occurs, the ATC 1008 can write another value, such as a pre-determined value (e.g., an error code indicating a type of error seen in the invalidation).

Page faults may be handled in the same or similar manner as described above with respect to FIG. 9, as shown in FIG. 10. That is, upon a page fault being detected, the ATC 1008 sends a message to the IOMMU 1006 and the IOMMU 1006 writes to a page request queue (PRQ) 1014 in the memory 1010 to indicate the page fault. The IOMMU 1006 then issues an interrupt to the host software 1004, which reads the PRQ 1014 and handles the page fault accordingly. As indicated in FIG. 10, there is still a page request (VMexit) and page request (VMenter) between the guest and host software for handling of page faults. However, in contrast to the example shown in FIG. 9, which utilizes a single PRQ for all ATCs, each ATC 1006 has a corresponding PRQ 1014 in the memory 1010.

In certain embodiments, an ATC may implement a minimum of two SWQs to avoid a denial of service (DoS) attack. For instance, one of the SWQs may be dedicated for use by the host software without interference from any guest software, which can avoid a DoS attack in which a malicious guest fills up a SWQ and prevents the host software from sending any commands to ATCs.

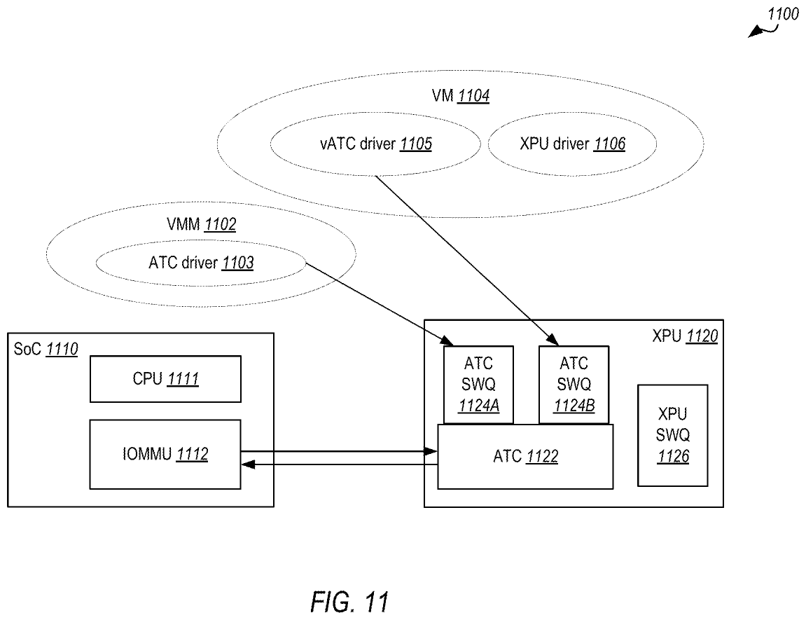

FIG. 11 illustrates an example implementation of multiple SWQs per ATC in accordance with embodiments of the present disclosure. In the example shown, the system 1100 includes a VMM 1102 that implements an ATC driver instance 1103 and a VM 1104 that implements a virtual ATC (vATC) driver instance 1105 and an XPU driver instance 1106. The system 1100 also includes an SoC 1110 with a CPU 1111 and an IOMMU 1112, which may be implemented in the same or similar manner as the IOMMUs described above. The IOMMU 1112 enables the XPU 1120 to implement SVM with the CPU 1111, as described above. The XPU 1120 may be an accelerator or other type of processor device, and includes an XPU-SWQ 1126 for queuing work/commands from the CPU 1111. In addition, the XPU 1120 includes an ATC 1122 with two ATC-SWQs 1124. As shown, the ATC-SWQ 1124A may be utilized solely by the host software/VMM 1102, while the ATC-SWQ 1124B may be utilized by the guest software 1104. That is, the ATC-SWQ 1124A may store commands from by the host software/VMM 1102, while the ATC-SWQ 1124B may store commands from the guest software application 1104 and/or other guest software applications running on the SoC 1110.

Shared Work Queue

In some embodiments, the ATC may advertise the number of SWQs and the total number of SWQ entries it supports in an ATS Capability Register (which is supported in current implementations, e.g., the PCIe ATS 1.1 specification). As described above, each SWQ may use an address that an invalidation command (e.g., EnqCmdS instruction) can use to target the SWQ. This address is referred to herein as the “Portal” of the SWQ. An invalidation command (e.g., EnqCmdS instruction) using any address from the Portal to Portal+2\hat{ }(SWQPORTSTRIDE+12), and that is 64 byte aligned, can write a new command into SWQ. The invalidation command (e.g., EnqCmdS) can be converted into a Defered Memory Write (DMWr) (or similar) packet on an IO-fabric (e.g., PCIe-based IO fabric). A DMWr that is not 64 byte aligned and targeting an SWQ Portal will be dropped by the SWQ.

Table 1 below shows an example formatting for an ATC SWQ advertisement in a capability register. As shown, a first 8 bits may be formatted according to current ATS specifications, e.g., the ATS 1.1 specification. A number N bits can then be used to indicate a number of SWQ entries across all of the SWQs. The number N can be a minimum of 2 bits, but can be any suitable number of bits. In some instances, the number N may be 5 bits. An SWQBAR field may be 2 bits as shown and can indicate where the SWQ Portals are located. An SWQPORTSTART can be 64 bits and indicate an offset into the MMIO BAR indicated by the SWQBAR field where a first Portal is located. Finally, an SWQPORTSTRIDE field can be 3 bits and can indicate a distance between Portals.

TABLE 1
Example values for ATC SWQ advertisement
in capability register

| Name | Description | Bits | Access Control |
|---|---|---|---|
| Legacy bits in | See ATS 1.1 | 8 | See ATS 1.1 |
| existing ATS | specification | | specification |
| capability register | | | |
| NUMSWQ | Number of SWQ | N (min = | RO |
| | Supported | 2 bits, e.g., | |
| | | 5 bits) | |
| TOTALSWQENT | Total number of | 16 | RO |
| | SWQ entries across | | |
| | all the SWQs | | |
| SWQBAR | MMIO BAR (base | 2 | RO |
| | address register) | | |
| | where SWQ Portals | | |
| | are located | | |
| SWQPORTSTART | Offset into | 64 | RO |
| | MMIOBAR where | | |
| | first SWQ Portal is | | |
| | located | | |
| SWQPORTSTRIDE | Distance between | 3 | RO |
| | Portals of two | | |
| | successive SWQs. If | | |
| | the value in field is | | |
| | x, the distance | | |
| | between each Portal | | |
| | is 2\hat{ }(x + 12) bytes | | |

For each SWQ, the ATC can provide Configuration Registers in the ATS Extended Capability Register of its device (e.g., XPUs 812). The SWQ Configuration information can include an SWQ Command Capability Register that indicates what commands guest software can support. If there are 32 (or less) commands supported from guest software to ATCs, then this register can be 32 bits in length, with each bit corresponding to a specific command. The host software can configure this 32 bit field to inform the ATC which commands are allowed by the specific SWQ. A command not allowed by an SWQ may be treated as a bad/illegal command and the ATC may accordingly abort the command and provide appropriate error information in the completion record (e.g., in 1012). This may prevent the guest software from sending invalidation commands that invalidate ATC entries belonging to other guests or to the host software.

The SWQ Configuration information can also include an SWQ Capability Register size field that specifies a number of entries in each SWQ. The host software can program the size field for each SWQ, ensuring that sum of size of each SWQ does not exceed the total number of SWQ entries specified by ATC in the ATS Capability Register (e.g., in the TOTALSWQENT of Table 1 above). ATC behavior may be undefined if this constraint is violated by software.

TABLE 2
Example SWQ Configuration information

| Field Name | Field Description | Bits | Access Control |
|---|---|---|---|
| Commands | Commands | 32 | RW |
| | supported by guest | | |
| | software | | |
| Size | Number of entries | 16 | RW |
| | in the work queue | | |

Invalidation Commands/EnqCmdS

In current systems, ATS may allow two different flavors of invalidations: (1) an invalidation without a processor address space identifier (PASID), and (2) an invalidation with a PASID. A PASID may identify a CPU process that has submitted work to an XPU, and each VM may have its own PASID associated therewith. Further, each VM may run multiple applications, each of which has its own PASID associated therewith. Embodiments herein, however, may utilize flavors of invalidation commands that do more than the existing flavors and have slightly different properties than either of the existing invalidation commands in ATS 1.0.

Table 3 below illustrates three example invalidation command formats that may be implemented by embodiments herein. Each command may include a command field (e.g., 5 bits) that indicates a type of invalidation command. A first command type (indicated in the third column of Table 3) further includes a size field that indicates a number of page(s) of memory, an address field that indicates a starting address of the page (or range of pages) indicated by the size field, a domain ID field to indicate that a translation is associated with a specific VM (e.g., may indicate a VM-id therein), a field for indicating a PASID of the process waiting for the invalidation completion as described above (PASIDc), and a field indicating a PASID of a process whose translations are being invalidated by the command (PASIDi). For example, an application executing on a VM may issue an invalidation command. The application may have a particular PASID associated therewith, and the VM may have a different PASID associated therewith. The application PASID may be indicated as PASIDi in the first command type, while the VM PASID may be indicated as PASIDc in the first command type. A second command type includes the same fields as the first command type, with the exception of the PASIDi field, and a third command type includes just the command indicator and the PASIDc field.

TABLE 3
Example invalidation command formats

| | | | Address- | |
|---|---|---|---|---|
| | | | range within | |
| | | | Domain (for | Global, |
| | | | all PASIDs | invalidate |
| | | Address- | in domain), | everything |
| | | range within | invalidates | in ATC, |
| | | PASID | for all | exists |
| | | within | apps/PASIDs | today in |
| Field | Description | Domain | in domain | ATS 1.0 |
| Cmd [4:0] Size | Command Number | 1 | 2 | 3 |
| | 0: one page | | | Not included |
| | 1: range of pages | | | |
| | (Same as ATS 1.0) | | | |
| Addr [63:12] | Start address of page | | | Not included |
| | (or range) | | | |
| | (Same as ATS 1.0) | | | |
| Domain-ID (VM-id) | Tag to identify | | | Not included |
| | translation belonging to | | | |
| | a specific VM (Domain) | | | |
| PASIDc | PASID of the process | PASID for | | |
| | waiting for invalidation | completion, | | |
| | completion | i.e., which | | |
| | | VM/PASID | | |
| | | to notify of | | |
| | | the | | |
| | | invalidation | | |
| PASIDi | PASID of the process | PASID for | Not included | Not included |
| | whose translations are | invalidation, | | |
| | being invalidated | i.e., what to | | |
| | | invalidate | | |

In certain embodiments, the third invalidation command above could be used for an address-range invalidation without a PASID/Domain, which would allow software to invalidate a range of address across all PASID/Domain and such an invalidation can be used to perform Global invalidation.

The host and guest software (system software) can submit commands to SWQs of an ATC using an EnqCmdS (or another equivalent type of) instruction, which is converted into a Deferred Memory Write (DMWr) packet on PCIe fabric for sending to the ATC. The invalidation command may, as described above, carry two different PASIDs: (1) a first PASID of the process whose entries are being invalidated in the ATC (PASIDi, e.g., a PASID of an application), and (2) a second PASID of the process who is receiving the completion (PASIDc, e.g., a PASID of VM or VMM). In current systems, the EnqCmdS only supports one PASID; however, with embodiments herein, the EnqCmdS may be extended to carry two PASIDs to allow for indicating both the PASIDi and PASIDc fields.

Page Request Group Response

In certain embodiments, system software may send another command type to ATC, and this command type may be referred to as a Page Request Group Response (PRGR). This command may be sent by system software after it has fixed the page-faults reported by the ATC, e.g., as described above. For instance, the ATC may send all Page Requests to host software, and only the host software may send PRGR to ATC. Host software can configure the guest-associated SWQ to treat a PRGR command as an illegal/bad command. Thus, if a page fault is in page-tables setup by the host, the host will fix the fault. Otherwise, the host will inject the page-fault into the guest and wait for a response. After fixing the guest page-fault, e.g., when the guest provides a PRGR to the host, the host can forward the command to the ATC.

Although certain commands are described above, additional commands may be implemented in other embodiments, as the command field may be 5 bits (as shown in Table 3) and accordingly supports 28 additional commands beyond those described above. Another benefit of moving away from a PCIe message based interface to an ATC (as described by ATS 1.0) is that there is no impact to IOMMU/Root-Complex for adding any such new commands.

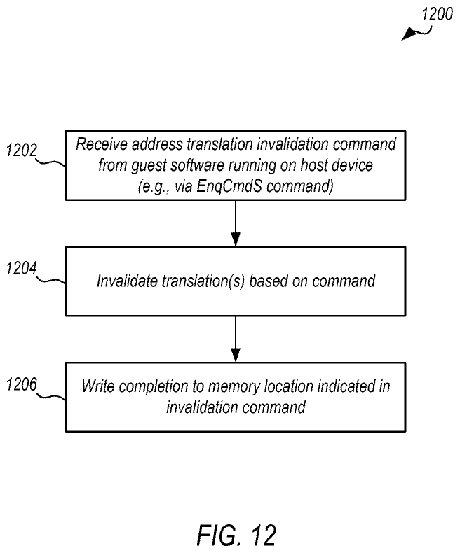

FIG. 12 illustrates a flow diagram of an example process 1200 of processing an address translation invalidation command in accordance with embodiments of the present disclosure. Operations in the example processes may be performed by hardware components of a device with an ATC and associated SWQ as described herein (e.g., XPU 812 with an ATC such as ATC 1008 and SWQ such as SWQ 1009). In some embodiments, a computer-readable medium may be encoded with instructions (e.g., a computer program) that implement one or more of the operations in the example processes. The example processes may include additional or different operations, and the operations may be performed in the order shown or in another order. In some cases, one or more of the operations shown in FIG. 12 are implemented as processes that include multiple operations, sub-processes, or other types of routines. In some cases, operations can be combined, performed in another order, performed in parallel, iterated, or otherwise repeated or performed another manner.

At 1202, an address translation invalidation command is received at a peripheral device (e.g., 812) from guest software (e.g., 1002) executing on host software (e.g., 1004) of a host device (e.g., 802). The command may include an indication of which address translations are to be invalidated in an ATC of the peripheral device (e.g., ATCs 816 or ATCs 1008) and a completion address (e.g., 1012) at which a completion status is to be written after the invalidation is performed. The command may be formatted in one of the formats described above, e.g., those in Table 3. In some embodiments, the command may be formatted as an EnqCmdS command. The invalidation command may be received at a SWQ (e.g., 1009) that is associated with the ATC storing the translations to be invalidated. For instance, the invalidation command may be received at an SWQ Portal address as described above. At 1204, address translations are invalidated in the ATC based on the command, and at 1206, a completion is written to the completion address indicated in the invalidation command. Thereafter, the guest software (e.g., 1002) that issued the invalidation command can determine whether the invalidation has been completed based on the value(s) written at the completion address in memory.

The foregoing disclosure has presented a number of example techniques for implementing an interface for guest software to submit commands to an ATC without host software or IOMMU as a middle agent, in a PCIe-based environment (which may also encompass a CXL-based environment as well). It should be appreciated that such techniques may be applied to other interconnect protocols. For instance, while some of the techniques discussed herein were described with reference to PCIe- or CXL-based protocols, it should be appreciated that techniques may apply to other interconnect protocols, such as OpenCAPI™, Gen-Z™, UPI, Universal Serial Bus, (USB), Cache Coherent Interconnect for Accelerators (CCIX™), Advanced Micro Device™'s (AMD™) Infinity™, Common Communication Interface (CCI), or Qualcomm™'s Centrig™ interconnect, among others, or to other types of packet-based protocols.

Note that the apparatus', methods', and systems described above may be implemented in any electronic device or system as aforementioned. As specific illustrations, the figures below provide exemplary systems for utilizing embodiments as described herein. As the systems below are described in more detail, a number of different interconnects are disclosed, described, and revisited from the discussion above. And as is readily apparent, the advances described above may be applied to any of those interconnects, fabrics, or architectures.

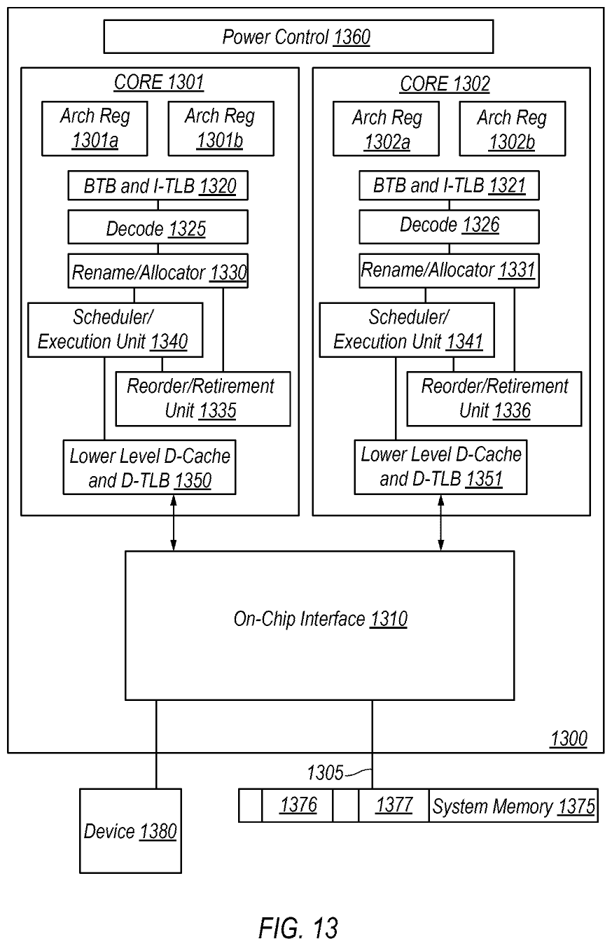

Referring to FIG. 13, an embodiment of a block diagram for a computing system including a multicore processor is depicted. Processor 1300 includes any processor or processing device, such as a microprocessor, an embedded processor, a digital signal processor (DSP), a network processor, a handheld processor, an application processor, a co-processor, a system on a chip (SOC), or other device to execute code. Processor 1300, in one embodiment, includes at least two cores—core 1301 and 1302, which may include asymmetric cores or symmetric cores (the illustrated embodiment). However, processor 1300 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1300, as illustrated in FIG. 13, includes two cores—core 1301 and 1302. Here, core 1301 and 1302 are considered symmetric cores, i.e. cores with the same configurations, functional units, and/or logic. In another embodiment, core 1301 includes an out-of-order processor core, while core 1302 includes an in-order processor core. However, cores 1301 and 1302 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 1301 are described in further detail below, as the units in core 1302 operate in a similar manner in the depicted embodiment.

As depicted, core 1301 includes two hardware threads 1301a and 1301b, which may also be referred to as hardware thread slots 1301a and 1301b. Therefore, software entities, such as an operating system, in one embodiment potentially view processor 1300 as four separate processors, i.e., four logical processors or processing elements capable of executing four software threads concurrently. As alluded to above, a first thread is associated with architecture state registers 1301a, a second thread is associated with architecture state registers 1301b, a third thread may be associated with architecture state registers 1302a, and a fourth thread may be associated with architecture state registers 1302b. Here, each of the architecture state registers (1301a, 1301b, 1302a, and 1302b) may be referred to as processing elements, thread slots, or thread units, as described above. As illustrated, architecture state registers 1301a are replicated in architecture state registers 1301b, so individual architecture states/contexts are capable of being stored for logical processor 1301a and logical processor 1301b. In core 1301, other smaller resources, such as instruction pointers and renaming logic in allocator and renamer block 1330 may also be replicated for threads 1301a and 1301b. Some resources, such as re-order buffers in reorder/retirement unit 1335, ILTB 1320, load/store buffers, and queues may be shared through partitioning. Other resources, such as general purpose internal registers, page-table base register(s), low-level data-cache and data-TLB 1315, execution unit(s) 1340, and portions of out-of-order unit 1335 are potentially fully shared.

Processor 1300 often includes other resources, which may be fully shared, shared through partitioning, or dedicated by/to processing elements. In FIG. 13, an embodiment of a purely exemplary processor with illustrative logical units/resources of a processor is illustrated. Note that a processor may include, or omit, any of these functional units, as well as include any other known functional units, logic, or firmware not depicted. As illustrated, core 1301 includes a simplified, representative out-of-order (OOO) processor core. But an in-order processor may be utilized in different embodiments. The OOO core includes a branch target buffer 1320 to predict branches to be executed/taken and an instruction-translation buffer (I-TLB) 1320 to store address translation entries for instructions.

Core 1301 further includes decode module 1325 coupled to fetch unit 1320 to decode fetched elements. Fetch logic, in one embodiment, includes individual sequencers associated with thread slots 1301a, 1301b, respectively. Usually core 1301 is associated with a first ISA, which defines/specifies instructions executable on processor 1300. Often machine code instructions that are part of the first ISA include a portion of the instruction (referred to as an opcode), which references/specifies an instruction or operation to be performed. Decode logic 1325 includes circuitry that recognizes these instructions from their opcodes and passes the decoded instructions on in the pipeline for processing as defined by the first ISA. For example, as discussed in more detail below decoders 1325, in one embodiment, include logic designed or adapted to recognize specific instructions, such as transactional instruction. As a result of the recognition by decoders 1325, the architecture or core 1301 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1326, in one embodiment, recognize the same ISA (or a subset thereof). Alternatively, in a heterogeneous core environment, decoders 1326 recognize a second ISA (either a subset of the first ISA or a distinct ISA).

In one example, allocator and renamer block 1330 includes an allocator to reserve resources, such as register files to store instruction processing results. However, threads 1301a and 1301b are potentially capable of out-of-order execution, where allocator and renamer block 1330 also reserves other resources, such as reorder buffers to track instruction results. Unit 1330 may also include a register renamer to rename program/instruction reference registers to other registers internal to processor 1300. Reorder/retirement unit 1335 includes components, such as the reorder buffers mentioned above, load buffers, and store buffers, to support out-of-order execution and later in-order retirement of instructions executed out-of-order.

Scheduler and execution unit(s) block 1340, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1350 are coupled to execution unit(s) 1340. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1301 and 1302 share access to higher-level or further-out cache, such as a second level cache associated with on-chip interface 1310. Note that higher-level or further-out refers to cache levels increasing or getting further way from the execution unit(s). In one embodiment, higher-level cache is a last-level data cache—last cache in the memory hierarchy on processor 1300—such as a second or third level data cache. However, higher level cache is not so limited, as it may be associated with or include an instruction cache. A trace cache—a type of instruction cache—instead may be coupled after decoder 1325 to store recently decoded traces. Here, an instruction potentially refers to a macro-instruction (i.e. a general instruction recognized by the decoders), which may decode into a number of micro-instructions (micro-operations).

In the depicted configuration, processor 1300 also includes on-chip interface module 1310. Historically, a memory controller, which is described in more detail below, has been included in a computing system external to processor 1300. In this scenario, on-chip interface 1310 is to communicate with devices external to processor 1300, such as system memory 1375, a chipset (often including a memory controller hub to connect to memory 1375 and an I/O controller hub to connect peripheral devices), a memory controller hub, a northbridge, or other integrated circuit. And in this scenario, bus 1305 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1375 may be dedicated to processor 1300 or shared with other devices in a system. Common examples of types of memory 1375 include DRAM, SRAM, non-volatile memory (NV memory), and other known storage devices. Note that device 1380 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1300. For example in one embodiment, a memory controller hub is on the same package and/or die with processor 1300. Here, a portion of the core (an on-core portion) 1310 includes one or more controller(s) for interfacing with other devices such as memory 1375 or a graphics device 1380. The configuration including an interconnect and controllers for interfacing with such devices is often referred to as an on-core (or un-core configuration). As an example, on-chip interface 1310 includes a ring interconnect for on-chip communication and a high-speed serial point-to-point link 1305 for off-chip communication. Yet, in the SOC environment, even more devices, such as the network interface, co-processors, memory 1375, graphics processor 1380, and any other known computer devices/interface may be integrated on a single die or integrated circuit to provide small form factor with high functionality and low power consumption.

In one embodiment, processor 1300 is capable of executing a compiler, optimization, and/or translator code 1377 to compile, translate, and/or optimize application code 1376 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

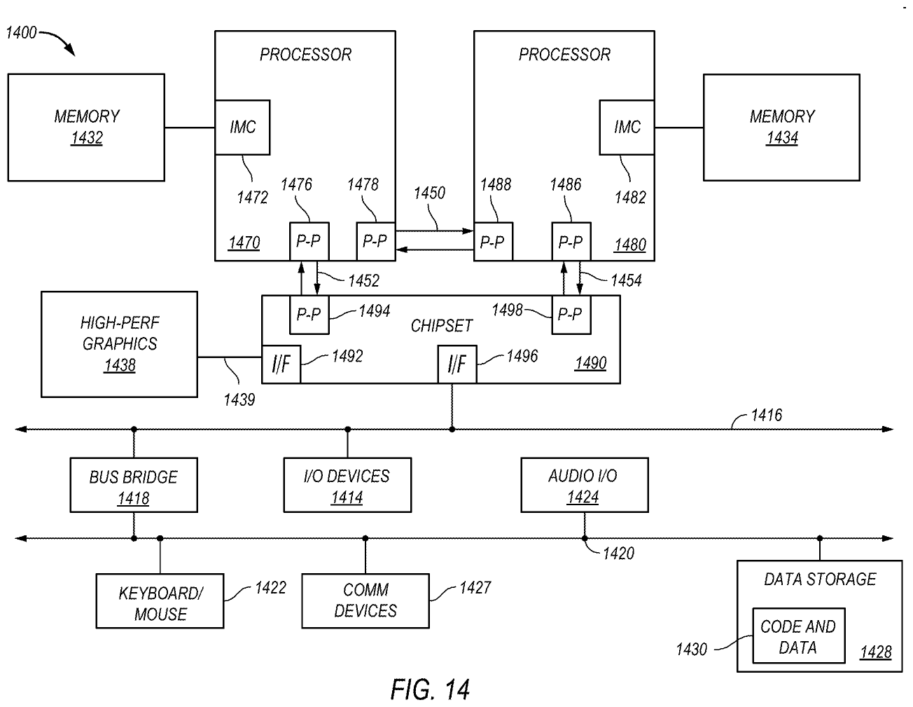

Referring now to FIG. 14, shown is a block diagram of another system 1400 in accordance with an embodiment of the present disclosure. As shown in FIG. 14, multiprocessor system 1400 is a point-to-point interconnect system, and includes a first processor 1470 and a second processor 1480 coupled via a point-to-point interconnect 1450. Each of processors 1470 and 1480 may be some version of a processor. In one embodiment, 1452 and 1454 are part of a serial, point-to-point coherent interconnect fabric, such as a high-performance architecture. As a result, aspects of the present disclosure may be implemented within the QPI architecture.

While shown with only two processors 1470, 1480, it is to be understood that the scope of the present disclosure is not so limited. In other embodiments, one or more additional processors may be present in a given processor.

Processors 1470 and 1480 are shown including integrated memory controller units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14, IMCs 1472 and 1482 couple the processors to respective memories, namely a memory 1432 and a memory 1434, which may be portions of main memory locally attached to the respective processors.

Processors 1470, 1480 each exchange information with a chipset 1490 via individual P-P interfaces 1452, 1454 using point to point interface circuits 1476, 1494, 1486, 1498. Chipset 1490 also exchanges information with a high-performance graphics circuit 1438 via an interface circuit 1492 along a high-performance graphics interconnect 1439.

A shared cache (not shown) may be included in either processor or outside of both processors; yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present disclosure is not so limited.

As shown in FIG. 14, various I/O devices 1414 are coupled to first bus 1416, along with a bus bridge 1418 which couples first bus 1416 to a second bus 1420. In one embodiment, second bus 1420 includes a low pin count (LPC) bus. Various devices are coupled to second bus 1420 including, for example, a keyboard and/or mouse 1422, communication devices 1427 and a storage unit 1428 such as a disk drive or other mass storage device which often includes instructions/code and data 1430, in one embodiment. Further, an audio I/O 1424 is shown coupled to second bus 1420. Note that other architectures are possible, where the included components and interconnect architectures vary. For example, instead of the point-to-point architecture of FIG. 14, a system may implement a multi-drop bus or other such architecture.

While aspects of the present disclosure have been described with respect to a limited number of embodiments, those skilled in the art will appreciate numerous modifications and variations therefrom. It is intended that the appended claims cover all such modifications and variations as fall within the true spirit and scope of this present disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ capable of/to,′ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the present disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Although each example described below is described with respect to Compute Express Link (CXL)-based protocols, any of the following examples may be utilized for a PCIe-based protocol, a Universal Serial Bus (USB)-based protocol, a Cache Coherent Interconnect for Accelerators (CCIX) protocol, or a Transmission Control Protocol/Internet Protocol (TCP/IP).

Example 1 is an apparatus comprising: a processor comprising an address translation cache (ATC); a shared work queue (SWQ) associated with the ATC; a port to couple to a host processor over a Peripheral Component Interconnect Express (PCIe)-based link; and circuitry to: receive address translation information from a memory management unit of the host processor, the address translation information comprising virtual memory address to physical memory address translations; store the address translation information in the ATC; receive a command from the host processor to modify information stored in the ATC; modify the information in the ATC based on the command; and store completion information in a memory location indicated by the command.

Example 1.5 includes the subject matter of Example 1, wherein the command is an invalidation command indicating an invalidation of address translation information stored in the ATC.

Example 2 includes the subject matter of Example 1 or 1.5, wherein the invalidation command is formatted as an EnqCmdS instruction.

Example 3 includes the subject matter of Example 1, 1.5, or 2, wherein the invalidation command includes an identifier of a process to which the completion is directed.

Example 4 includes the subject matter of any one of Examples 1-3, wherein the invalidation command includes an identifier of a process that is associated with the invalidation of the address translation information.

Example 5 includes the subject matter of any one of Examples 1-4, wherein the invalidation command includes an identifier of a virtual machine associated with the address translation information.

Example 6 includes the subject matter of any one of Examples 1-5, wherein the invalidation command includes a command type identifier.

Example 7 includes the subject matter of any one of Examples 1-6, wherein the apparatus further comprises a capability register to advertise the SWQ to the host processor.

Example 8 includes the subject matter of Example 7, wherein the capability register comprises fields to indicate one or more of: a number of SWQs of the apparatus, a total number of SWQ entries of the apparatus, one or more SWQ memory locations for guest software of the host processor to write invalidation commands to, and a stride between SWQ memory locations.

Example 9 includes the subject matter of Example 7, wherein the capability register comprises, for each SWQ of the apparatus, a field to indicate a set of commands that are supported by the SWQ and a number of entries in the SWQ.

Example 10 includes the subject matter of any one of Examples 1-9, wherein the SWQ is a first SWQ to store commands from a guest software application running on the host processor, and the apparatus further comprises a second SWQ associated with the ATC to commands from for a host software application running on the host processor.

Example 11 is a method comprising: receiving, from guest software executing on a host processor, a command to modify information stored in an address translation cache (ATC) of an accelerator; modifying address translation information stored in the ATC based on the command; and storing completion information in a memory location indicated by the command.

Example 11.5 includes the subject matter of Example 11, wherein the command is an invalidation command indicating an invalidation of address translation information stored in the ATC.

Example 12 includes the subject matter of Example 11, wherein the command is formatted as an EnqCmdS instruction.

Example 13 includes the subject matter of Example 11 or 12, wherein the command includes an identifier of a process to which the completion is directed.

Example 14 includes the subject matter of any one of Examples 11-13, wherein the command includes an identifier of a process that is associated with the invalidation of the address translation information.

Example 15 includes the subject matter of any one of Examples 11-14, wherein the command includes an identifier of a virtual machine associated with the address translation information.

Example 16 includes the subject matter of any one of Examples 11-15, wherein the command includes a command type identifier.

Example 17 is a system comprising: a memory; a host processor; an input/output memory management unit (IOMMU); and a processing device (XPU) coupled to the host processor and memory via a Peripheral Component Interconnect Express (PCIe)-based link, the processing device comprising an accelerator, an address translation cache (ATC), and a shared work queue (SWQ) corresponding to the ATC, wherein the processing device is to: receive address translation information from the IOMMU, the address translation information comprising virtual memory address to physical memory address translations used by the host processor; store the address translation information in the ATC; receive an invalidation command from guest software executing on the host processor; modify address translation information stored in the ATC based on the invalidation command; and store completion information in a memory location indicated by the invalidation command.

Example 18 includes the subject matter of Example 17, wherein the invalidation command is formatted as an EnqCmdS instruction.

Example 19 includes the subject matter of Example 17 or 18, wherein the invalidation command includes an identifier of a process to which the completion is directed.

Example 20 includes the subject matter of any one of Examples 17-19, wherein the invalidation command includes an identifier of a process that is associated with the invalidation of the address translation information.

Example 21 includes the subject matter of any one of Examples 17-20, wherein the invalidation command includes an identifier of a virtual machine associated with the address translation information.

Example 22 includes the subject matter of any one of Examples 17-21, wherein the invalidation command includes a command type identifier.

Example 23 includes the subject matter of any one of Examples 17-22, wherein the apparatus further comprises a capability register to advertise the SWQ to the host processor.

Example 24 includes the subject matter of Example 23, wherein the capability register comprises fields to indicate one or more of: a number of SWQs of the apparatus, a total number of SWQ entries of the apparatus, one or more SWQ memory locations for guest software of the host processor to write invalidation commands to, and a stride between SWQ memory locations.

Example 25 includes the subject matter of Example 23, wherein the capability register comprises, for each SWQ of the apparatus, a field to indicate a set of commands that are supported by the SWQ and a number of entries in the SWQ.

Example 26 includes the subject matter of any one of Examples 17-25, wherein the SWQ is a first SWQ to store commands from a guest software application running on the host processor, and the apparatus further comprises a second SWQ associated with the ATC to store commands from a host software application running on the host processor.

Example X1 includes an apparatus comprising means to perform one or more elements of a method described in or related to any of Examples 11-16 above, or any other method or process described herein.

Example X2 includes an apparatus comprising logic, modules, or circuitry to perform one or more elements of a method described in or related to any of Examples 11-16 above, or any other method or process described herein.

Example X3 includes a system comprising: one or more processors and one or more computer-readable media comprising instructions that, when executed by the one or more processors, cause the one or more processors to perform the method, techniques, or process as described in or related to any of Examples 11-16 above, or portions thereof

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing, a detailed description has been given with reference to specific exemplary embodiments. It will, however, be evident that various modifications and changes may be made thereto without departing from the broader spirit and scope as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a processor comprising an address translation cache (ATC);
a shared work queue (SWQ) associated with the ATC;
a port to couple to a host processor over a Peripheral Component Interconnect Express (PCIe)-based link; and
circuitry to:
receive address translation information from a memory management unit of the host processor, the address translation information comprising virtual memory address to physical memory address translations;
store the address translation information in the ATC;
receive a command from the host processor to modify information stored in the ATC;
modify the information in the ATC based on the command; and
store completion information in a memory location indicated by the command.

2. The apparatus of claim 1, wherein the command is an invalidation command indicating an invalidation of address translation information stored in the ATC.

3. The apparatus of claim 1, wherein the command is formatted as an EnqCmdS instruction.

4. The apparatus of claim 1, wherein the command includes an identifier of a process to which the completion is directed.

5. The apparatus of claim 1, wherein the command includes an identifier of a process that is associated with the invalidation of the address translation information.

6. The apparatus of claim 1, wherein the command includes an identifier of a virtual machine associated with the address translation information.

7. The apparatus of claim 1, wherein the command includes a command type identifier.

8. The apparatus of claim 1, wherein the processor further comprises a capability register to advertise the SWQ to the host processor.

9. The apparatus of claim 8, wherein the capability register comprises fields to indicate one or more of: a number of SWQs of the apparatus, a total number of SWQ entries of the apparatus, one or more SWQ memory locations for guest software of the host processor to write commands to, and a stride between SWQ memory locations.

10. The apparatus of claim 8, wherein the capability register comprises, for each SWQ of the apparatus, a field to indicate a set of commands that are supported by the SWQ and a number of entries in the SWQ.

11. The apparatus of claim 1, wherein the SWQ is a first SWQ to store commands from one or more guest software applications running on the host processor, and the apparatus further comprises a second SWQ associated with the ATC to store commands from a host software application running on the host processor.

12. A method comprising:
receiving, from guest software executing on a host processor, a command to modify information stored in an address translation cache (ATC) of an accelerator;
modifying the information stored in the ATC based on the command; and
storing completion information in a memory location indicated by the command.

13. The method of claim 12, wherein the command is an invalidation command indicating an invalidation of address translation information stored in the ATC.

14. The method of claim 12, wherein the command is formatted as an EnqCmdS instruction.

15. The method of claim 12, wherein the command includes an identifier of a process to which the completion is directed.

16. The method of claim 12, wherein the command includes an identifier of a process that is associated with the invalidation of the address translation information.

17. The method of claim 12, wherein the command includes an identifier of a virtual machine associated with the address translation information.

18. The method of claim 12, wherein the command includes a command type identifier.

19. A system comprising:
a memory;
a host processor;
an input/output memory management unit (IOMMU); and
a processing device coupled to the host processor and memory via a Peripheral Component Interconnect Express (PCIe)-based link, the processing device comprising an accelerator, an address translation cache (ATC), and a shared work queue (SWQ) corresponding to the ATC, wherein the processing device is to:
receive address translation information from the IOMMU, the address translation information comprising virtual memory address to physical memory address translations used by the host processor;
store the address translation information in the ATC;
receive an invalidation command from guest software executing on the host processor;
modify address translation information stored in the ATC based on the invalidation command; and
store completion information in the memory location indicated by the invalidation command.

20. The system of claim 19, wherein the invalidation command is formatted as an EnqCmdS instruction.

21. The system of claim 19, wherein the invalidation command includes an identifier of a process to which the completion is directed.

22. The system of claim 19, wherein the invalidation command includes an identifier of a process that is associated with the invalidation of the address translation information.

23. The system of claim 19, wherein the invalidation command includes an identifier of a virtual machine associated with the address translation information.

24. The system of claim 19, wherein the invalidation command includes a command type identifier.

25. The system of claim 19, wherein the apparatus further comprises a capability register to advertise the SWQ to the host processor.
